(19) United States
(12) Patent Application Publication
(10) Pub. No.: US 2026/0309877 A1
(43) Pub. Date: Oct. 8, 2026

(54) Cryogenic Detector for Measuring Radioactivity in a Sample

(71) Applicants: Istituto Nazionale Di Fisica Nucleare, Frascati (Roma) (IT); Gran Sasso Science Institute, L'Aquila (AQ) (IT)

(72) Inventors: Luca Pattavina, Frascati (Roma) (IT); Andrei Puiu, Frascati (Roma) (IT); Lorenzo Pagnanini, L'Aquila (IT); Giovanni Benato, L'Aquila (IT)

(21) Appl. No.: 19/482,354

(22) PCT Filed: May 21, 2024
(86) PCT No.: PCT/IB2024/054925

§ 371 Date: Nov. 7, 2025

(30) Foreign Application Priority Data
May 25, 2023 (IT) 102023000010539

(51) Int. Cl. G01T 1/167; G01T 1/00; G01T 1/16; G01T 1/17

(52) U.S. Cl. CPC G01T 1/167; G01T 1/006; G01T 1/1606; G01T 1/17

(57) ABSTRACT

Detector for measuring radioactivity in a sample, the detector being configured to operate at a cryogenic temperature and including: a crystal absorber, in which a cavity is formed for receiving a sample whose radioactivity is to be measured, the crystal absorber being configured to produce phonons in response to an interaction of an ionizing radiation with the crystal absorber, at least one thermal sensor configured to detect a variation in the temperature of the crystal absorber in response to a production of phonons in the crystal absorber, and electronics configured to determine the energy deposited by the ionizing radiation in the crystal absorber as a function of the temperature variation.

### BACKGROUND OF THE DISCLOSURE

### 1. The Field of the Disclosure

The present invention relates, in general, to techniques for measuring radioactivity in a sample.

### 2. The Relevant Technology

In the field of environmental safety and human health, the monitoring of samples that may have come in contact with radionuclides of anthropogenic or natural origin is of the utmost importance.

The experimental techniques currently in use for assessing the radioactivity of environmental (and other) matrices involve the use of detectors specifically selected according to the type of radiation to be investigated, as well as specific sample treatments (e.g., ashing, electrodeposition) aimed at improving measurement sensitivity. Traditionally, the most common detectors are high-purity germanium diodes for gamma radiation detection, silicon-barrier detectors for alpha radiation detection, silicon-drift detectors for X radiation detection, and liquid scintillators for beta radiation detection.

In order to obtain robust results with high accuracy, it is necessary to use large sample masses on many detectors, resulting in long measurement times or requiring the adoption of complex chemical/radiochemical processes for sample preparation, which induce systematic effects that are not always controllable and reproducible in the overall measurement efficiency.

It is an object of the present invention to provide a solution which can overcome, at least partly, the drawbacks of the prior art.

In the light of the above object, a detector for measuring radioactivity in a sample is an object of the invention, said detector being configured to operate at cryogenic temperatures and comprising: a crystal absorber, in which a cavity is formed for receiving a sample whose radioactivity is to be measured, said crystal absorber being configured to produce phonons in response to an interaction of an ionizing radiation with the crystal absorber,
a thermal sensor configured to detect a temperature variation in response to a production of phonons in the crystal absorber, and
electronics configured to determine the energy deposited by the ionizing radiation in the crystal absorber as a function of said temperature variation.

### SUMMARY OF THE DISCLOSURE

The present invention arises from the observation that solid-state cryogenic detectors (cryogenic calorimeters) currently developed for studying the fundamental properties of dark matter and neutrinos can be easily adapted for measuring radioactive contamination of different sample types. The main advantages of using cryogenic calorimeters are: high sensitivity to all types of radiation, and flexibility in the detector's geometry (i.e., maximized detection efficiency). The direct consequence is that no sample treatment is required to estimate the radioactive material content of the matrix. Furthermore, in order to achieve a level of sensitivity comparable with that of current technologies, it is not required to use samples with masses in the order of kg and measurement times of weeks, but fractions of a gram and measurement times of less than one day will suffice.

The techniques described herein can be implemented in any analysis laboratory without requiring specific cryogenics skills. This has been made possible by the latest cryogenics advancements that have followed the development of quantum technologies. In fact, cryogenic infrastructures capable of cooling samples from room temperature to tens of mK in ~24 h without using any cryogenic liquid.

### BRIEF DESCRIPTION OF THE DRAWINGS

The features and advantages of the detector according to the invention will become clearer in the light of the following detailed description with reference to the accompanying drawings, provided herein merely for illustrative and non-limiting purposes, wherein:

FIG. 1 is a schematic representation of a cryogenic detector according to the invention;

FIGS. 2 and 3 are, respectively, a perspective view and a sectional view of a crystal absorber of the detector of FIG. 1;

FIGS. 4 and 5 are, respectively, a perspective view and a sectional view of a second embodiment of the crystal absorber;

FIG. 6 is a graph representing an example of an electric signal supplied by a thermal sensor of the detector of FIG. 1;

FIG. 7 is a graph representing the relationship between the energy E_{dep,H} deposited by an ionizing radiation in the crystal absorber in the form of a temperature variation ΔT and the energy E_{dep,L} deposited by the radiation in the crystal absorber and re-emitted in the form of photons.

### DETAILED DESCRIPTION OF THE PREFERRED EMBODIMENTS

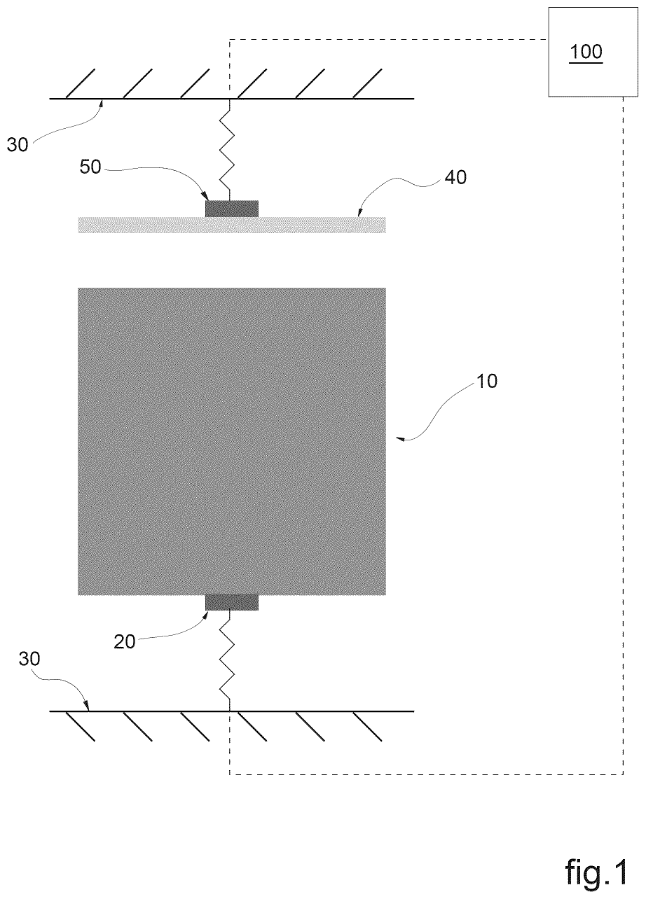

FIG. 1 schematically shows a cryogenic detector for measuring radioactivity in a sample, comprising a crystal absorber 10, which is configured to produce phonons, e.g., coherent excitations of the crystalline structure, in response to an interaction of a radiation to be detected with the crystal absorber 10. The absorber may be made of, for example, TeO₂ (tellurium oxide). For example, a commercially available TeO₂ crystal, having a mass of 750 g (a cube with 5 cm edges), if kept at a temperature of 10 mK, has a thermal capacity of ~2×10⁻⁹ J/K. Other materials which may be used for detecting radioactive contaminants and which can be processed/manipulated for producing specific geometries include, for example, Si (silicon), Ge (germanium), PbWO₄ (lead tungstate), BGO (bismuth germanate).

The phonons produced in the absorber 10 gradually lose coherence, turning into heat. By measuring the temperature, it is thus possible to reconstruct the energy released by the ionizing radiation in the crystal absorber 10.

Therefore, the cryogenic detector comprises also a thermal sensor 20 disposed in contact with the absorber 10 and configured to detect a temperature variation in response to the absorption of the phonons in the crystal absorber 10. The thermal sensor 20 may be, for example, a thermistor. Electronics 100 is associated with the thermal sensor 20 for determining the energy deposited by the ionizing radiation in the crystal absorber 10 as a function of the measured temperature variation. From the deposited energy it is then possible to compute, by means of known formulae, a value of the activity of the radionuclides contained in the sample.

The cryogenic detector is operated at cryogenic temperatures of the order of tens of mK (a hundredth of a Kelvin degree), so as to minimize the thermal capacity of the absorber 10 and make it more sensitive to temperature variations induced by the interacting particle/radiation. To this end, the crystal absorber 10 and the sensor 20 are positioned in a cryostat 30, which is barely sketched in FIG. 1.

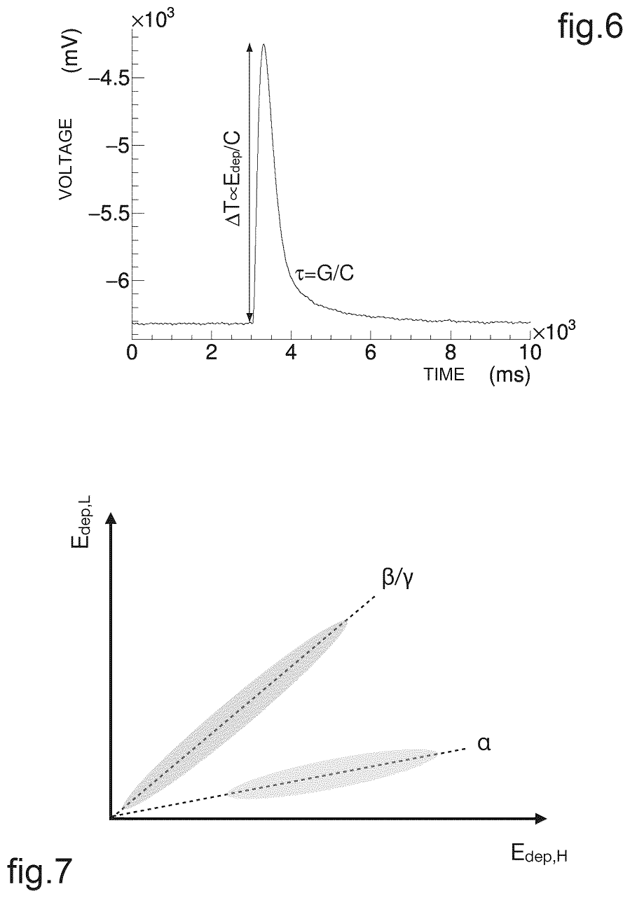

The temperature variation ΔT in the crystal+sensor system is proportional to the energy E_{dep} deposited in the crystal according to the following relation

$$Δ T ∝ {E}_{dep} / C \qquad ( 1 )$$

where C is the thermal capacity of the crystal+sensor system. One example of a signal provided by a thermal sensor in the form of a thermistor in response to a temperature variation ΔT is shown in the graph of FIG. 6. The numerical values shown in the graph are merely illustrative and should not be understood as limiting. In the graph, T₀ indicates the nominal operating temperature of the sensor, i.e., the cryogenic temperature determined by the cryostat. The voltage value at time t=0 is determined by a voltage generator coupled to the thermistor. The temperature variation ΔT induces in the sensor a change in electric resistance, and hence a variation in the voltage measured across the thermistor. The variation in the measured voltage is, therefore, a function of the temperature variation, and hence of the energy deposited in the crystal. The electric signal then decays with a decay time τ=C/G, where G is the conductance toward the thermal bath and measures the “speed” at which the power absorbed by the detector (due to radiation absorption) is discharged towards the bath.

A release of 1 MeV of energy in an absorbing crystal may induce, for example, a variation of 3 MΩ in the resistance of the thermal sensor (thermistor), which corresponds to an increase of ~20 μK in the temperature of the crystal+sensor system.

The cryogenic detector is almost an ideal calorimeter, i.e., all the energy deposited in the absorbing crystal is converted into a thermal signal and measured.

Cryogenic detectors have a high energy resolution (around 1/1000) over a wide energy range (from a few keV to some MeV). This property is of primary importance to identify radioactive emissions that are characteristic of contaminants of interest. More specifically, it makes it possible to achieve high signal-to-noise ratios at low (X rays, E~keV), medium (γ rays, E<2.6 MeV) and high (α particles, E>3 MeV) energy.

In the crystal absorber 10, a cavity configured to receive the sample whose radioactivity is to be measured is formed. In effect, therefore, the absorber 10 is configured to approximately surround or enclose the sample in a complete manner. This particular geometry of the absorber makes it possible to maximise the efficiency in detecting the signal produced by radioactive contaminants, while decreasing the amount of material required and the time necessary for the measurement.

In practice, the crystal absorber 10 may comprise a plurality of crystal elements separable from each other to gain access to the cavity formed inside the crystal absorber 10.

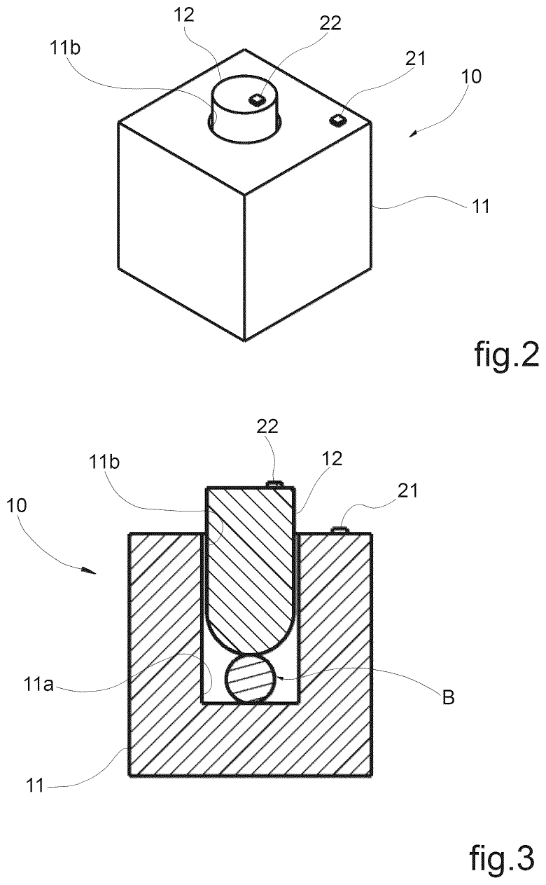

FIGS. 2 and 3 show one possible exemplary embodiment of the crystal absorber 10. In this example, the crystal absorber 10 comprises a first crystal element, which forms a container or casing in which the cavity 11a is formed for receiving the sample B whose radioactivity is to be measured. The cavity 11a defines, on one face of the first crystal element 11, a mouth 11b allowing access to the cavity 11a. Said mouth 11b is closed by a second crystal element 12, which forms a cover or plug that can be coupled with the first crystal element 11. With each one of the crystal elements 11, 12, a respective thermal sensor 21, 22 of the above-described type is associated.

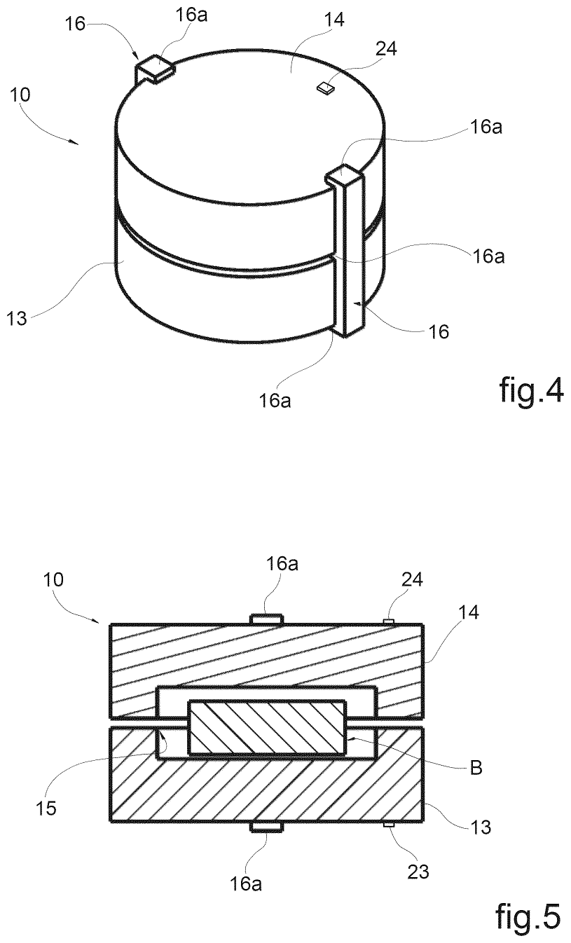

FIGS. 4 and 5 show another possible example of an embodiment of the crystal absorber 10. In this example, the crystal absorber 10 comprises a first crystal element 13 and a second crystal element 14 forming respective half-shells which can be coupled with each other to form a container or casing in which the cavity 15 is formed for receiving the sample B whose radioactivity is to be measured. With each one of the crystal elements 13, 14, a respective thermal sensor 23, 24 of the above-described type is associated. In the illustrated example, the crystal elements 13, 14 are held together by a plurality of removable retaining elements 16 provided with laterally protruding teeth 16a, e.g., made of bronze or polytetrafluoroethylene (PTFE). The retaining elements 16 are peripherally coupled with the crystal elements 13, 14 and retain such elements between their respective teeth 16a.

The crystal of the absorber 10 may also be a scintillator crystal, configured to emit photons in response to an interaction of the radiation to be detected with the absorber 10 (in this case, a small part of the absorbed energy will not translate into an increase in the temperature of the absorber, since it will be re-emitted as light). In this case, it will be possible to use in the cryogenic detector a light absorber 40, e.g., made of germanium or silicon, susceptible of a temperature variation in response to an absorption of the photons in the light absorber 40. A second thermal sensor 50, in particular a thermistor, may be coupled with the light absorber 40 to detect the temperature variation in the light absorber 40, similarly to the thermal sensor 20 associated with the crystal absorber 10. In this case, the deposited energy E_{dep} will be the energy of the photons absorbed in the light absorber 40.

Advantageously, the combined use of the crystal absorber 10 and the light absorber 40 makes it possible not only to determine the energy deposited by the radiation in the crystal absorber 10, but also to discriminate among radiation types. It is known, in fact, that the ratio between the energy E_{dep,H} deposited by the radiation in the crystal absorber 10 in the form of a temperature variation ΔT and the energy E_{dep}, L deposited by the radiation in the crystal absorber 10 and re-emitted in the form of photons is constant and depends on the type of radiation involved (see FIG. 7).

The above-described detector can therefore be used for simultaneously measuring the activities of different contaminants in the sample, whereas with conventional detectors, on the contrary, it was necessary to use different detectors, one for each type of radiation involved. For example, a sample contaminated with ¹³¹I and ⁹⁰Sr had to be tested by using both a gamma detector and a beta detector.

Furthermore, the fact that the above-described detector permits conducting a complete study on the sample by taking just a single measurement for different radiation types implies that, after having fully characterized the detector's response to different radiation types by means of known sources, the uncertainty related to detection efficiency can be significantly reduced.

Unlike conventional detectors, the above-described detector also permits measuring small quantities of material (grams), so that self-absorption of the beta signal in the material is mitigated.

1. A detector for measuring radioactivity in a sample, said detector being configured to operate at a cryogenic temperature and comprising:
a crystal absorber, in which a cavity is formed for receiving a sample whose radioactivity is to be measured, said crystal absorber being configured to produce phonons in response to an interaction of an ionizing radiation with the crystal absorber,
at least one thermal sensor configured to detect a variation in the temperature of the crystal absorber in response to a production of phonons in the crystal absorber, and
electronics configured to determine the energy deposited by the ionizing radiation in the crystal absorber as a function of said temperature variation.

2. The detector according to claim 1, wherein the crystal absorber is configured to surround or enclose the sample in a substantially complete manner.

3. The detector according to claim 1, wherein the crystal absorber comprises a plurality of crystal elements separable from each other to gain access to said cavity, each of said crystal elements being associated with a respective thermal sensor configured to detect a variation in the temperature of the respective crystal element.

4. The detector according to claim 1, wherein the crystal absorber is further configured to emit photons in response to an interaction of the ionizing radiation with the crystal absorber, and wherein the cryogenic detector further comprises:
a light absorber susceptible of a temperature variation in response to an absorption of the photons in the light absorber, and
a second thermal sensor coupled to the light absorber to detect said temperature variation in the light absorber.

5. The detector according to claim 4, wherein said electronics is further configured to determine the energy E_{dep,L} deposited by the ionizing radiation in the crystal absorber and re-emitted in the form of photons as a function of said variation in the temperature of the light absorber.

6. The detector according to claim 5, wherein said electronics is configured to distinguish among different types of ionizing radiation as a function of the ratio between the energy E_{dep,H} deposited by the ionizing radiation in the crystal absorber in the form of phonons and the energy E_{dep,L} deposited by the ionizing radiation in the crystal absorber and re-emitted in the form of photons.

7. The detector according to claim 1, wherein said cryogenic temperature is of the order of magnitude of tens of mK.
